(19) United States
(12) Patent Application Publication
(10) Pub. No.: US 2024/0154271 A1
(43) Pub. Date: May 9, 2024

(54) SECONDARY BATTERY, SECONDARY BATTERY MODULE, AND SECONDARY BATTERY PACK INCLUDING THE SAME

(71) Applicant: SK On Co., Ltd., Seoul (KR)

(72) Inventor: Yong Hee LEE, Daejeon (KR)

(21) Appl. No.: 18/501,034

(22) Filed: Nov. 3, 2023

(30) Foreign Application Priority Data
Nov. 8, 2022 (KR) 10-2022-0148145

(51) Int. Cl. H01M 50/54; H01M 50/178

(52) U.S. Cl. CPC H01M 50/54; H01M 50/178

(57) ABSTRACT

The secondary battery according to an embodiment of the present invention comprises: a battery case; an electrode assembly accommodated inside the battery case and including a plurality of electrodes; a first upper electrode tab connected to electrodes belonging to a first electrode group among the electrodes; a first lower electrode tab connected to electrodes belonging to a second electrode group among the electrodes; a first electrode lead electrically connected to the first upper electrode tab; and a second electrode lead electrically connected to the first lower electrode tab and spaced apart from the first electrode lead, wherein the electrodes belonging to the first electrode group may have a polarity that is the same as polarity of the electrodes belonging to the second electrode group.

### CROSS-REFERENCE TO RELATED PATENT APPLICATION

The present application claims priority under 35 U.S.C. § 119(a) to Korean patent application number 10-2022-0148145 filed on Nov. 8, 2022, in the Korean Intellectual Property Office, the entire disclosure of which is incorporated by reference herein.

### BACKGROUND OF THE INVENTION

### 1. Field

Embodiments of the present invention relate to secondary battery, secondary battery module, and secondary battery pack including the same.

### 2. Description of the Related Art

A pouch-type secondary battery includes an electrode assembly in which a cathode and an anode are alternately stacked with a separator therebetween; an electrode lead extending from an electrode assembly; and a battery case accommodating an electrode assembly and an electrolyte.

An electrode lead, which is a part that is connected to an electrode assembly and exposed to an outside of a battery case, serves as an electrode terminal that may be electrically connected to another secondary battery or an external device. Such an electrode lead may be connected to an electrode tab that is directly connected to an electrode assembly. Here, at least one cathode tab and at least one anode tab may be connected to a cathode lead and an anode lead, respectively.

In the prior art, an electrode tab has a structure in which multiple electrode plates of an electrode assembly and one electrode tab are welded. In this case, when a high current is applied to an electrode assembly through rapid charging, a local heat generation phenomenon occurs at a position where the current is concentrated. Due to this heat generation phenomenon, there is a problem that decomposition of an electrolyte and deterioration of electrode plates occur in a battery case.

### SUMMARY OF THE INVENTION

Embodiments of the present invention provide a secondary battery, a secondary battery module, and a secondary battery pack including the same in which a heat generation phenomenon during rapid charging is improved and liquid leakage generation is controlled.

A secondary battery according to an embodiment of the present invention includes: a battery case; an electrode assembly accommodated inside the battery case and including a plurality of electrodes; a first upper electrode tab connected to electrodes belonging to a first electrode group among the electrodes; a first lower electrode tab connected to electrodes belonging to a second electrode group among the electrodes; a first electrode lead electrically connected to the first upper electrode tab; and a second electrode lead electrically connected to the first lower electrode tab and spaced apart from the first electrode lead, wherein the electrodes belonging to the first electrode group may have a polarity that is the same as polarity of the electrodes belonging to the second electrode group.

A secondary battery module according to an embodiment of the present invention may include a plurality of the secondary batteries.

A secondary battery pack according to an embodiment of the present invention may include a plurality of the secondary battery modules.

According to the present technology, a secondary battery with improved rapid charging performance, a secondary battery module, and a secondary battery pack including the same can be provided.

### BRIEF DESCRIPTION OF THE DRAWINGS

FIG. 1 is a cross-sectional diagram schematically illustrating a portion of a secondary battery of the prior art.

FIG. 2 is a time (second)-temperature (° C.) graph for each position in a secondary battery of the prior art.

FIG. 3 is a diagram and a photograph of a case in which a liquid leakage phenomenon occurs in an electrode assembly of a secondary battery of the prior art and a case in which it does not.

FIG. 4 is a cross-sectional diagram illustrating a portion of a cross-section of a secondary battery according to one embodiment of the present invention.

FIG. 5 is a cross-sectional diagram illustrating a portion of a cross-section of a secondary battery according to another embodiment of the present invention.

FIG. 6 is a cross-sectional diagram illustrating a portion of a cross-section of a secondary battery according to an embodiment of the present invention.

FIG. 7 is a cross-sectional diagram illustrating a cross-section of a secondary battery according to one embodiment of the present invention.

### DETAILED DESCRIPTION

The structural or functional descriptions of Examples disclosed in the present specification or application are merely illustrated for the purpose of explaining Examples according to the technical principle of the present invention, and Examples according to the technical principle of the present invention may be implemented in various forms in addition to the Examples disclosed in the specification of application. In addition, the technical principle of the present invention is not construed as being limited to the Examples described in the present specification or application.

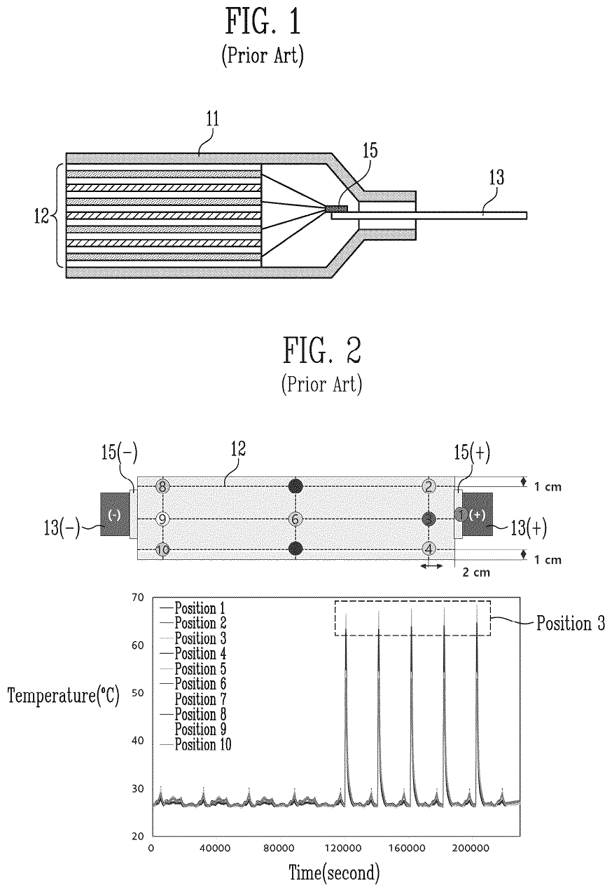

FIG. 1 is a cross-sectional diagram schematically illustrating a portion of a secondary battery of the prior art.

A secondary battery may include an electrode assembly 12 in which a cathode and an anode are alternately stacked with a separator therebetween; an electrode lead 13; and a battery case 11.

A battery case 11 may accommodate an electrode assembly 12 and an electrolyte. The shape of a battery case 11 may be a prismatic shape, a cylindrical shape, a pouch shape, etc., but is not limited to a specific shape.

An electrode assembly 12 may include a plurality of anodes, a plurality of cathodes, and separators.

A cathode and an anode may each include a current collector and an active material layer disposed on the current collector. For example, a cathode may include a cathode current collector and a cathode active material layer, and an anode may include an anode current collector and an anode active material layer.

A current collector may include a known conductive material to within a range where a chemical reaction is caused within a lithium secondary battery. For example, a current collector may include any one of stainless steel, nickel (Ni), aluminum (Al), titanium (Ti), copper (Cu), and an alloy thereof, and may be provided in various forms such as a film, a sheet, and a foil.

An active material layer includes an active material. For example, a cathode active material layer may include a cathode active material, and an anode active material layer may include an anode active material.

A cathode active material may be a material which lithium (Li) ions may be inserted to and extracted from. A cathode active material may be an lithium metal oxide. For example, a cathode active material may be one of a lithium manganese-based oxide, a lithium nickel-based oxide, lithium cobalt-based oxide, a lithium nickel manganese-based oxide, a lithium nickel cobalt manganese-based oxide, a lithium nickel cobalt aluminum-based oxide, a lithium iron phosphate-based compound, a lithium manganese phosphate-based compound, a lithium cobalt phosphate-based compound, and a lithium vanadium phosphate-based compound, but is not necessarily limited to a specific example.

An anode active material may be a material which lithium ions may be absorbed to and extracted from. For example, an anode active material may be any one of carbon-based materials such as crystalline carbon, amorphous carbon, a carbon composite, and a carbon fiber, a lithium alloy, silicon (Si), and tin (Sn). Depending on an embodiment, an anode active material may be natural graphite or artificial graphite, but is not limited to a specific example.

A cathode plate and an anode plate may each further include a binder and a conductive material.

A binder may mediate bonding between a current collector and an active material layer, thus improving mechanical stability. According to an embodiment, a binder may be an organic binder or an aqueous binder, and may be used with a thickener such as carboxymethyl cellulose (CMC). According to an embodiment, an organic binder may be any one of a vinylidene fluoride-hexafluoropropylene copolymer (PVDF-co-HFP), polyvinylidene fluoride (PVDF), polyacrylonitrile, and polymethyl methacrylate, and an aqueous binder may be styrene-butadiene rubber (SBR), but is not necessarily limited thereto.

A conductive material may improve electrical conductivity of a lithium secondary battery. A conductive material may include a metal-based material. According to an embodiment, a conductive material may include a typical carbon-based conductive material. For example, a conductive material may include any one of graphite, carbon black, graphene, and carbon nanotubes. Preferably, a conductive material may include carbon nanotubes.

A separator may be disposed between a cathode and an anode. A separator is configured to prevent electrical short-circuiting between a cathode and an anode and to generate a flow of ions.

According to an embodiment, a separator may include a porous polymer film or a porous non-woven fabric. Here, a porous polymer film may be configured as a single layer or multiple layers including a polyolefin-based polymer such as an ethylene polymer, a propylene polymer, an ethylene/butene copolymer, an ethylene/hexene copolymer, and an ethylene/methacrylate copolymer. A porous non-woven fabric may include glass fibers of a high melting point and polyethylene terephthalate fibers. However, it is not limited to thereto, and depending on an embodiment, a separator may be a highly heat-resistant separator (CCS; Ceramic Coated Separator) including ceramic.

An electrolyte may be a non-aqueous electrolyte. An electrolyte solution may include a lithium salt and an organic solvent.

According to an embodiment, an organic solvent may include one of propylene carbonate (PC), ethylene carbonate (EC), diethyl carbonate (DEC), dimethyl carbonate (DMC), ethylmethyl carbonate (EMC), methylpropyl carbonate (MPC), dipropyl carbonate. (DPC), vinylene carbonate (VC), dimethyl sulfoxide, acetonitrile, dimethoxyethane, diethoxyethane, sulfolane, gamma-butyrolactone, propylene sulfide, and tetrahydrofuran.

An electrode lead 13, which is a part that is connected to an electrode assembly 12 and exposed to an outside of a battery case 11, serves as an electrode terminal that may be electrically connected to another secondary battery or an external device. Such an electrode lead 13 may be connected to an electrode tab 15 that is directly connected to an electrode assembly 12. An electrode tab 15 may include a cathode tab extending from a cathode and an anode tab extending from an anode. In one embodiment, a cathode tab and an anode tab may protrude from a cathode and an anode, respectively, in a direction perpendicular to a direction of contact with a separator, that is, in a longitudinal direction. A cathode tab and an anode tab may protrude in the same direction along a longitudinal direction, or may protrude in opposite directions along a longitudinal direction. Here, at least one cathode tab and at least one anode tab may be connected to a cathode lead and an anode lead, respectively.

FIG. 2 is a time (second)-temperature (° C.) graph for each position in a secondary battery of the prior art.

At least one cathode tab 15(+) and at least one anode tab 15(−) may be connected to a cathode lead 13(+) and an anode lead 13(−), respectively.

In the prior art, electrode tabs 15(+) and 15(−) have a structure in which multiple electrode plates of an electrode assembly 12 and one electrode tab 15(+) or 15(−) are welded. In this case, when a high current is applied to an electrode assembly 12 through rapid charging, a local heat generation phenomenon occurs at a position where the current is concentrated. Due to this heat generation phenomenon, there is a problem that decomposition of an electrolyte and deterioration of electrode plates occur in a battery case 11.

Referring to FIG. 2, it may be confirmed that when a high current is applied to the electrode assembly 12, the part where the current is concentrated and a local heat generation phenomenon thus occurs is Position 3.

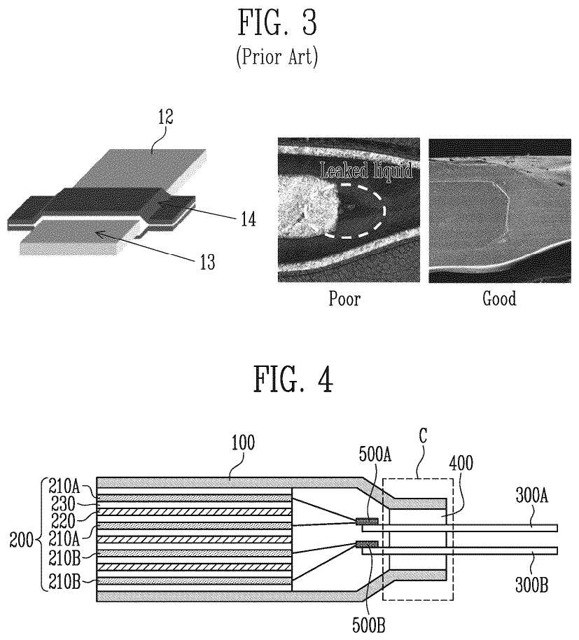

FIG. 3 is a diagram and a photograph of a case in which a liquid leakage phenomenon occurs in an electrode assembly of a secondary battery of the prior art and a case in which it does not.

In the prior art, alleviation of a local heat generation phenomenon requires an increase of the thickness of an electrode tab 15. However, when the thickness of an electrode tab 15 increases, a liquid leakage phenomenon may occur due to an adhesion problem between a metal and a polymer within an electrode tab 15.

To solve the problem described above, an embodiment of the present invention differentiates electrode tabs connected to upper electrodes and electrode tabs connected to lower electrodes in an electrode assembly, thereby securing a wide current path to alleviate a local heat generation phenomenon.

In addition, electrode tabs connected to upper electrodes and electrode tabs connected to lower electrodes may be welded within a battery case, thereby improving mechanical strength.

In addition, an electrolyte leakage phenomenon may be controlled by the structure between a battery case, an insulating tape, and electrode tabs.

Hereinafter, a secondary battery according to an embodiment of the present invention will be described.

According to one embodiment of the present invention, provided is a secondary battery including: a battery case; an electrode assembly accommodated inside the battery case and including a plurality of electrodes; a first upper electrode tab connected to electrodes belonging to a first electrode group among the electrodes; a first lower electrode tab connected to electrodes belonging to a second electrode group among the electrodes; a first electrode lead electrically connected to the first upper electrode tab; and a second electrode lead electrically connected to the first lower electrode tab and spaced apart from the first electrode lead, wherein the electrodes belonging to the first electrode group may have a polarity that is the same as polarity of the electrodes belonging to the second electrode group.

FIG. 4 is a cross-sectional diagram illustrating a portion of a cross-section of a secondary battery according to one embodiment of the present invention.

Referring to FIG. 4, a secondary battery according to a first embodiment of the present invention may include a battery case 100, an electrode assembly 200, electrode leads 300A, 300B, and electrode tabs 500A, 500B.

A battery case 100 forms an exterior of a secondary battery, and may package therein an electrode assembly 200, electrode leads 300A, 300B, and electrode tabs 500A, 500B, which will be described later.

An electrode assembly 200 is accommodated inside a battery case 100, and a cathode and an anode may be alternately stacked with a separator therebetween.

Electrode plates (positive and negative) of an electrode assembly 200 may be formed by applying an active material slurry to an electrode current collector. An active material slurry may typically be formed by adding a solvent to a granular active material, an auxiliary conductor, a binder, and a plasticizer and stirring the resulting mixture. In addition, an uncoated area where the active material slurry is not applied may be presented in each electrode plate, and electrode tabs 500A and 500B, which will be described later and which correspond to each electrode plate, may be formed in this uncoated area.

A separator may be disposed between a cathode and an anode. A separator may be configured to prevent electrical short-circuiting between a cathode and an anode and to generate a flow of ions.

Electrode plates (positive and negative) of an electrode assembly 200 may be divided into a plurality of electrode groups. For example, electrodes 210A, 210B having a first polarity (positive and negative) may be divided into a first electrode group and a second electrode group. In one embodiment, a first electrode group and a second electrode group may be differentiated in consideration of the positions of electrodes. For example, electrodes positioned above a preset position may be divided into a first electrode group 210A, and electrodes positioned below a preset position may be divided into a second electrode group. However, division of electrode groups is not limited to the form shown in FIG. 4, and electrode groups may be divided into various forms according to need. For example, electrodes positioned in an edge may be divided into a first electrode group, and electrodes positioned in an interior of the electrodes included in the first electrode group may be divided into a second electrode group. In addition, the number of electrodes included in a first electrode group and the number of electrodes included in a second electrode groups may be the same or may be different from each other. In addition, in FIG. 4, electrodes having a first polarity are illustrated as being divided into two electrode groups, but they are not limited thereto, and they may be divided into three or more electrode groups.

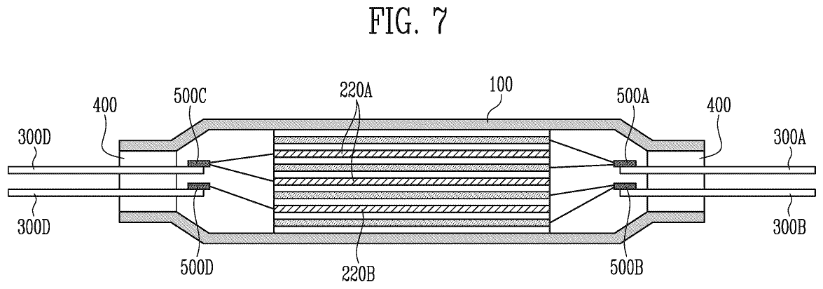

Electrodes 220 having a second polarity (negative or positive) may be selectively divided into a third electrode group and a fourth electrode group. Electrodes 220 having a second polarity (negative or positive) will be described in more detail in the description about FIG. 7 below.

An electrode tab connected to electrodes 210A belonging to a first electrode group may be defined as a first upper electrode tab 500A. An electrode tab connected to electrodes 2106 belonging to a second electrode group may be defined as a first lower electrode tab 500B. In one embodiment, a first upper electrode tab 500A may be disposed to be spaced apart from a first lower electrode tab 5006.

A first upper electrode tab 500A may be electrically connected to a first electrode lead 300A. A first lower electrode tab 500B may be electrically connected to a second electrode lead 300B.

A first electrode lead 300A and a second electrode lead 300B may be disposed to be spaced apart from each other. A first electrode lead 300A and a second electrode lead 300B may extend from an inside of a battery case 100 to protrude outward. In one embodiment, electrode tabs 500A, 500B may be joined to electrode leads 300A, 300B through laser welding.

The present invention can secure a wide current path through a first electrode lead 300A extending from a first upper electrode tab 500A and a second electrode lead 300B extending from a first lower electrode tab 500B, thereby suppressing deterioration of an electrode plate due to a local heat generation phenomenon during charging. In other words, the amount of heat generated can be dispersed, thereby shortening the time of rapid charging.

A battery case 100 may include an insulating member 400. An insulating member 400 can prevent short-circuiting between a battery case 100 and electrode leads 300A, 300B and improve a sealing force of a battery case 100. In an embodiment, a first electrode lead 300A and a second electrode lead 300B may pass through an insulating member 400 and extend outside a battery case 100.

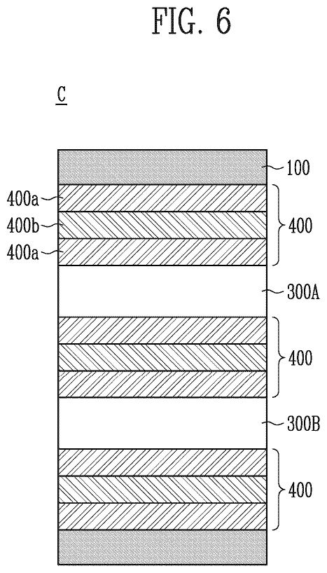

The specific structure of an insulating member 400 will be described in more detail in the description about FIG. 6 below.

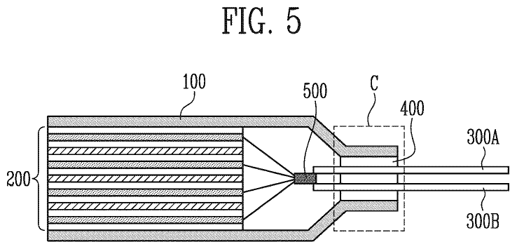

FIG. 5 is a cross-sectional diagram illustrating a portion of a cross-section of a secondary battery according to another embodiment of the present invention.

Referring to FIGS. 4 and 5, a secondary battery according to another embodiment of the present invention may be similar to the secondary battery according to FIG. 4 except for the description below.

In one embodiment, as described with reference to FIG. 4, first electrode tabs 500A, 500B may be disposed to be spaced apart from each other as a first upper electrode tab 500A and a first lower electrode tab 500B inside a battery case 100.

On the other hand, referring to FIG. 5, a first upper electrode tab 500A connected to an electrode 210A of a first electrode group and a first lower electrode tab 500B connected to an electrode 210B of a second electrode group may come into contact with each other. In other words, a first upper electrode tab 500A and a first lower electrode tab 500B may come into contact with each other to form a combined electrode tab 500.

A combined electrode tab 500 may be electrically connected to a first electrode lead 300A and a second electrode lead 300B. A first electrode lead 300A and A second electrode lead 300B may be disposed to be spaced apart from each other. A first electrode lead 300A and a second electrode lead 300B may extend from an inside of a battery case 100 to protrude outward.

In other words, in the secondary battery according to another embodiment of the present invention, electrode leads 300A and 300B are arranged to be spaced apart from each other, but electrode tabs come into contact with each other to form a combined electrode tab 500, thereby improving mechanical strength of the secondary battery.

FIG. 6 is a cross-sectional diagram illustrating a portion of a cross-section of a secondary battery according to an embodiment of the present invention. FIG. 6 is an enlarged cross-sectional diagram of area C in FIGS. 4 and 5.

Referring to FIG. 6, an insulating member 400 may include a first portion, which is between a battery case 100 and a first electrode lead 300A; a second portion, which is between a first electrode lead 300A and a second electrode lead 300B; and a third portion, which is between a second electrode lead 300B and a battery case 100.

Each of a first portion, a second portion, and a third portion may include an adhesive layer 400a and an insulating layer 400b. In an embodiment, an adhesive layer 400a may contact with one or more of a battery case 100, a first electrode lead 300A, and a second electrode lead 300B.

In one embodiment, an insulating layer 400b may be disposed between adhesive layers 400a that are spaced apart from each other. For example, within a first portion of an insulating member 400, an insulating layer 400b may be disposed between an adhesive layer 400a in contact with a battery case 100 and an adhesive layer 400a in contact with a first electrode lead 300A. In addition, within a second portion of an insulating member 400, an insulating layer 400b may be disposed between an adhesive layer 400a in contact with a first electrode lead 300A and an adhesive layer 400a in contact with a second electrode lead 300B. In addition, within a third portion of an insulating member 400, an insulating layer 400b may be disposed between an adhesive layer 400a in contact with a second electrode lead 300B and an adhesive layer 400a in contact with a battery case 100.

In one embodiment, an insulating layer 400b may include polyolefin, for example, polypropylene (PP), which has insulating properties and excellent processability and moldability, thereby making sealing of a battery case 100 easy.

In one embodiment, an adhesive layer 400a may include modified polyolefin, for example, it may include acid-modified polyolefin synthesized through solution polymerization by introducing a polar group to non-polar polyolefin, for example, it may include acid modified polypropylene (PPa). Accordingly, a binding force to a polar group may increase, thereby implementing excellent adhesion to electrode leads 300A, 300B or a battery case 100. For example, the polar group may be maleic anhydride.

By an insulating member 400 having the structure shown in FIG. 6, an electrolyte leakage phenomenon that may occur due to an adhesion problem between a metal and a polymer near electrode leads 300A and 300B can be controlled.

FIG. 7 is a cross-sectional diagram illustrating a cross-section of a secondary battery according to one embodiment of the present invention.

Referring to FIGS. 4 and 7, electrodes 210A, 210B having a first polarity (positive or negative) illustrated in FIG. 4 and electrodes 220A, 220B having a second polarity (negative or positive), which is a different polarity, may be divided into a third electrode group and a fourth electrode group.

In one embodiment, a third electrode group and a fourth electrode group may be differentiated in consideration of the positions of electrodes. For example, electrodes positioned above a preset position may be divided into a third electrode group 210A, and electrodes positioned below a preset position may be divided into a fourth electrode group.

An electrode tab connected to electrodes 220A belonging to a third electrode group may be defined as a second upper electrode tab 500C. An electrode tab connected to electrodes 220B belonging to a fourth electrode group may be defined as a second lower electrode tab 500D. In one embodiment, a second upper electrode tab 500C may be disposed to be spaced apart from a second lower electrode tab 500D.

A second upper electrode tab 500C may be electrically connected to a third electrode lead 300C. A second lower electrode tab 500D may be electrically connected to a fourth electrode lead 300D.

A third electrode lead 300C and a fourth electrode lead 300D may be disposed to be spaced apart from each other. A third electrode lead 300C and a fourth electrode lead 300D may extend from an inside of a battery case 100 to protrude outward. In one embodiment, electrode tabs 500C, 500D may be joined to electrode leads 300C, 300D through laser welding.

In FIG. 7, electrodes 220A, 220B having a second polarity (negative or positive) are illustrated such that electrode tabs 500C, 500D and electrode leads 300C, 300D are formed in the same form as in FIG. 4, but they are not limited thereto.

In another embodiment, for electrodes 220A, 220B having a second polarity (negative or positive), electrode tabs 500C, 500D may come into contact with each other to form a combined electrode tab 500, as shown in FIG. 5.

In yet another embodiment, electrodes 220A, 220B having a second polarity (negative or positive) consist of a single electrode group so that electrodes of a second polarity may be electrically connected to one electrode tab and one electrode lead.

According to another embodiment of the present invention, a secondary battery module including a plurality of the secondary batteries is provided.

According to yet another embodiment of the present invention, a secondary battery pack including a plurality of the secondary battery modules is provided.

What is claimed is:

1. A secondary battery comprising:
a battery case;
an electrode assembly accommodated inside the battery case and including a plurality of electrodes;
a first upper electrode tab connected to electrodes belonging to a first electrode group among the electrodes;
a first lower electrode tab connected to electrodes belonging to a second electrode group among the electrodes;
a first electrode lead electrically connected to the first upper electrode tab; and
a second electrode lead electrically connected to the first lower electrode tab and spaced apart from the first electrode lead,
wherein the electrodes belonging to the first electrode group have a polarity that is the same as polarity of the electrodes belonging to the second electrode group.

2. The secondary battery according to claim 1, wherein the electrode assembly includes a cathode and an anode that are alternately stacked with a separator therebetween.

3. The secondary battery according to claim 1, wherein the first electrode lead and the second electrode lead extend from an inside of the battery case to protrude outward.

4. The secondary battery according to claim 3, wherein the first electrode lead and the second electrode lead pass through an insulating member included in the battery case to extend outside the battery case.

5. The secondary battery according to claim 4, wherein the insulating member comprises a first portion, which is between the battery case and the first electrode lead; a second portion, which is between the first electrode lead and the second electrode lead; and a third portion, which is between the second electrode lead and the battery case.

6. The secondary battery according to claim 5, wherein the first portion, the second portion, and the third portion each comprise an insulating layer and an adhesive layer.

7. The secondary battery according to claim 6, wherein the adhesive layer contacts with at least one of the battery case, the first electrode lead, and the second electrode lead.

8. The secondary battery according to claim 7, wherein the insulating layer is disposed between adhesive layers spaced apart from each other.

9. The secondary battery according to claim 1, wherein the first upper electrode tab and the first lower electrode tab are spaced apart from each other.

10. The secondary battery according to claim 1, wherein the first upper electrode tab and the first lower electrode tab contact with each other.

11. The secondary battery according to claim 1, further comprising:
a second upper electrode tab connected to electrodes belonging to a third electrode group among the electrodes; and
a second lower electrode tab connected to electrodes belonging to a fourth electrode group among the electrodes;
wherein the electrodes belonging to the third electrode group and the fourth electrode group have a polarity that is different from the electrodes belonging to the first electrode group and the second electrode group.

12. The secondary battery according to claim 11, further comprising:
a third electrode lead electrically connected to the second upper electrode tab; and
a fourth electrode lead electrically connected to the second lower electrode tab and spaced apart from the third electrode lead.

13. The secondary battery according to claim 12, wherein the third electrode lead and the fourth electrode lead extend from an inside of the battery case to protrude outward.

14. The secondary battery according to claim 13, wherein a direction in which the third electrode lead and the fourth electrode lead protrude is different from a direction in which the first electrode lead and the second electrode lead protrude.

15. The secondary battery according to claim 14, wherein the third electrode lead and the fourth electrode lead pass through an insulating member included in the battery case to extend outside the battery case.

16. The secondary battery according to claim 12, wherein the second upper electrode tab and the second lower electrode tab are spaced apart from each other.

17. The secondary battery according to claim 12, wherein the second upper electrode tab and the second lower electrode tab contact with each other.

18. A secondary battery module comprising a plurality of the secondary batteries according to claim 1.

19. A secondary battery pack comprising a plurality of the secondary battery modules according to claim 18.
